(19) United States
(12) Patent Application Publication
(10) Pub. No.: US 2007/0062572 A1
(43) Pub. Date: Mar. 22, 2007

(54) Photovoltaic system

(76) Inventors: Lee S. Judd, Louisville, KY (US); William M. Bland, Shepherdsville, KY (US)

Correspondence Address: KING & SCHICKLI, PLLC, 247 NORTH BROADWAY, LEXINGTON, KY, 40507, US

(21) Appl. No.: 11/229,863

(22) Filed: Sep. 19, 2005

(51) Int. Cl. H02N 6/00

(52) U.S. Cl. 136/244

(57) ABSTRACT

A photovoltaic system for an electronic device. The system includes a first photovoltaic cell primarily oriented toward the sun and a second photovoltaic cell primarily oriented toward a light source of the electronic device. The first and second photovoltaic cells are in electrical communication to provide electricity to the electronic device. The second photovoltaic cell recaptures some of the electricity used to power the electronic device and reuses this electricity in the photovoltaic system.

### TECHNICAL FIELD

The present invention relates generally to a photovoltaic system and, more specifically, to an electronic device utilizing the system. The photovoltaic system includes at least two photovoltaic cells with at least one of the cells recapturing some of the electricity used to power the device.

### BACKGROUND OF THE INVENTION

In recent years, solar radiation has become a desirable source for electric energy. The light and heat created by the sun provides a sustainable supply of electricity that may be utilized for powering electronic devices. Photovoltaic cells, sometimes referred to as solar cells, are a common device used to capture the sun's energy and convert it to electricity. Beneficially, these cells may also capture other forms of light energy, such as artificial light from conventional light sources, and convert it to electricity.

Given the inherent benefits of light energy, photovoltaic cells have been adapted to provide primary and supplementary power to many devices. For instance, small groups of cells are often used to power portable, handheld devices, such as calculators. The cells are also grouped in large arrays to provide power to homes or power grids.

When using photovoltaic cells with small electronic devices, one will often utilize batteries or other means for storing the electricity the cells generate. For example, yard and walkway lights often include a single panel of solar cells positioned on a top surface of the light with a bank of rechargeable batteries positioned within the light. During the daylight hours the panel receives solar energy and converts it to electricity stored in the rechargeable batteries. As nighttime darkness sets in, the light becomes activated and the energy stored in the rechargeable battery powers the light.

Many of these lights incorporating a single solar panel fail to have enough electric power to provide a desired brightness or duration of light. In an attempt to remedy this problem, some have developed solar panels having a larger footprint and array of cells that may capture more solar energy. Unfortunately, these larger panels are often unsightly and occupy great amounts of space. Moreover, utilizing a single, large panel with a portable device is impractical because it makes the device difficult to transport and use. Accordingly, manufactures utilizing photovoltaic cells in portable devices only use a single photovoltaic cell directed toward one source of light energy. This limits the amount of electricity that the cell may generate, therein requiring either constant exposure to a light source or additional sources of electricity.

Accordingly, the electronic arts have need for a photovoltaic system that provides additional power to an electronic device. The system would include multiple photovoltaic cells primarily oriented to different light sources to provide the electronic device with additional power.

### SUMMARY OF THE INVENTION

In accordance with the purposes of the present invention as described herein, a new and improved photovoltaic system is described. The photovoltaic system includes a first photovoltaic cell primarily oriented toward the sun and a second photovoltaic cell primarily oriented toward a light source of the electronic device. The photovoltaic system may also include an electrical storage device that resides in electrical communication with the first and second photovoltaic cells, such that it receives the electricity produced by the cells.

In one embodiment, the electronic device comprises a light having a housing containing a light source. The light also includes a first photovoltaic cell oriented toward the sun and a second photovoltaic cell oriented primarily toward the light source. The first and second photovoltaic cells reside in electrical communication with an electrical storage device. In one embodiment, the light comprises a lantern having a housing including a light transmissive region that enables light to pass and illuminate an area surround the housing. The lantern may also include a light source positioned within the housing and a lid positioned on top of the housing. The lid retains the first photovoltaic cell primarily oriented toward the sun and the second photovoltaic cell primarily oriented toward the light source. In this embodiment, the first photovoltaic cell resides substantially outside the housing, while the second photovoltaic cell resides substantially within the housing. Accordingly, the first and second photovoltaic cells have substantially identical footprints.

In another embodiment, the electronic device comprises a cellular phone, wherein the phone includes the first photovoltaic cell on the exterior of the phone primarily oriented toward the sun. The phone also includes a second photovoltaic cell residing on the interior of the phone primarily oriented toward a display of the phone.

In the following description there is shown and described one possible embodiment of this invention, simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view of one embodiment of the photovoltaic system of the present invention;

FIG. 2 is a front view of one embodiment of an electronic device including the photovoltaic system of FIG. 1;

FIG. 3a is a top view of the electronic device of FIG. 2 showing a first photovoltaic cell;

FIG. 3b is a view along the line X-X of FIG. 2 showing a second photovoltaic cell; and

FIGS. 4a and 4b are diagrammatic views of a second embodiment of an electronic device including the photovoltaic system of FIG. 1.

### DETAILED DESCRIPTION OF THE INVENTION

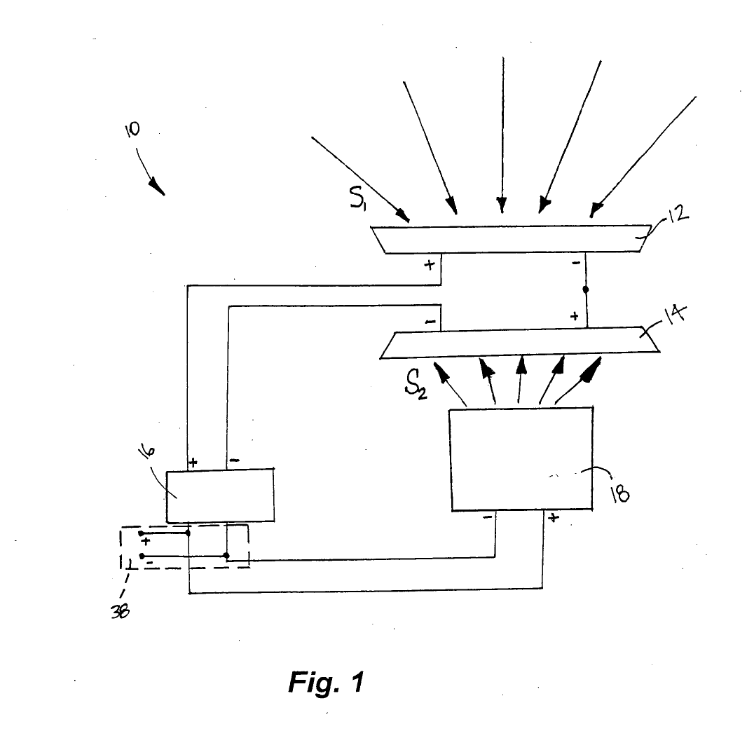

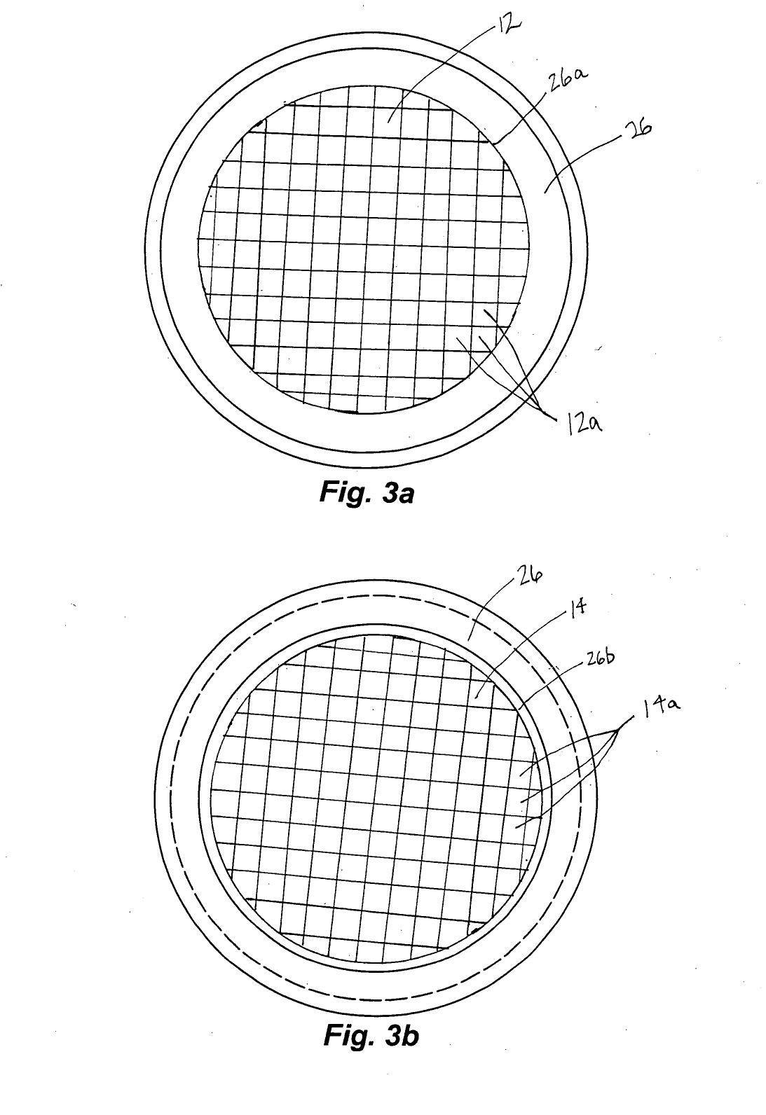

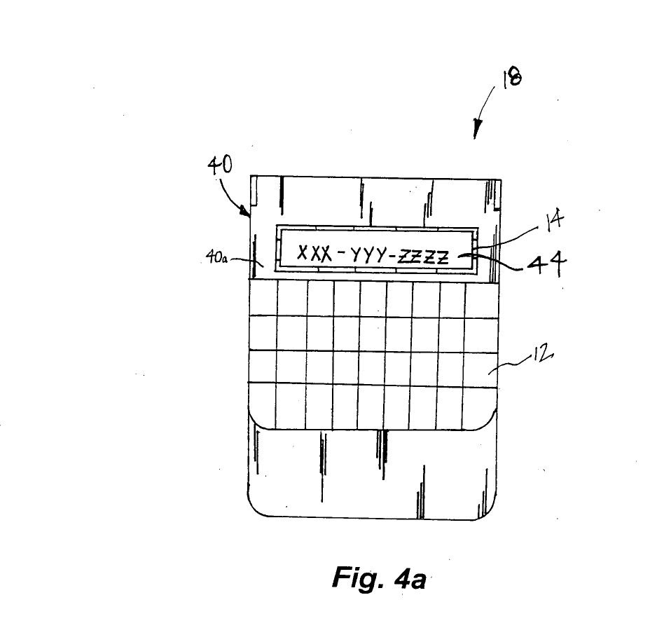

Reference is now made to the diagrammatic view of FIG. 1 illustrating one embodiment of the photovoltaic system 10 of the present invention. As mentioned above, one of the features of the present photovoltaic system 10 is its ability to not only capture and store electrical power from ambient or natural light (e.g., sunlight), but also to capture and store electrical power from the electronic device it powers. In its most basic embodiment, the photovoltaic system 10 includes a first photovoltaic cell 12, a second photovoltaic cell 14, and an electrical storage device 16 that will power an electronic device 18 having a light source. Although sometimes referred to herein as a “cell,” one will appreciate that the first and second photovoltaic cells 12, 14, may each comprise a plurality or array of cells 12a, 14a (FIGS. 3a and 3b).

As illustrated in FIG. 1, the first photovoltaic cell 12 resides primarily oriented toward the sun. Often this will result in the first photovoltaic cell 12 becoming positioned on the exterior of the electronic device 18. This positioning exposes the first photovoltaic cell 12 to the maximum amount of ambient or natural light S₁. The light S₁ may take the form of sunlight, moonlight, or artificial light from sources auxiliary to the electronic device 18.

The second photovoltaic cell 14 resides primarily oriented toward a light source S₂ of the electronic device 18. In some instances, this will result in the second photovoltaic cell becoming positioned in the interior of the electronic device 18. This enables it to receive artificial light emanating from the electronic device 18, as well as possible ambient or natural light, or light from sources auxiliary to the electronic device 18.

The first and second photovoltaic cells 12, 14, may be formed of any material capable of capturing light energy and converting it to electricity. For instance, semiconductor material, such as silicon, often provides the desired properties for the cells. As is known in the art, a portion of the light that strikes the first and second photovoltaic cells 12, 14, becomes absorbed within the semiconductor material. This energy causes electrons to become freed from the atoms of the silicon material. An electric field in the cells 12, 14 guides the free electrons in a certain direction. Placing electric connections in communication with this source of free electrons enables a user to capture the electrons or current from the cells 12, 14.

The electrical storage device 16 may comprise any device that receives and distributes electricity. In one embodiment, it comprises a bank of rechargeable batteries. Any number and type of batteries may be used, depending on the amount of power required by the electronic device 18. As shown in FIG. 1, the electrical storage device 16 resides in electrical communication with the first and second photovoltaic cells 12, 14. In one embodiment, the first and second photovoltaic cells 12, 14 each include a positive and negative terminal. The negative terminal of the first photovoltaic cell 12 and the positive terminal of the second photovoltaic cell 14 are electrically connected, while the positive terminal of the first photovoltaic cell 12 and the negative terminal of the second photovoltaic cell 14 are electrically connected to the electrical storage device 16 for providing electricity to the electrical storage device 16. As shown, the electrical storage device 16 is positioned electrically between the first and second photovoltaic cells 12, 14 and the light source of the electronic device 18. In other words, the electrical storage device 16 resides electrically upstream of the light source of the electronic device 18 and an optional power source for providing electricity to an auxiliary device, discussed below in further detail.

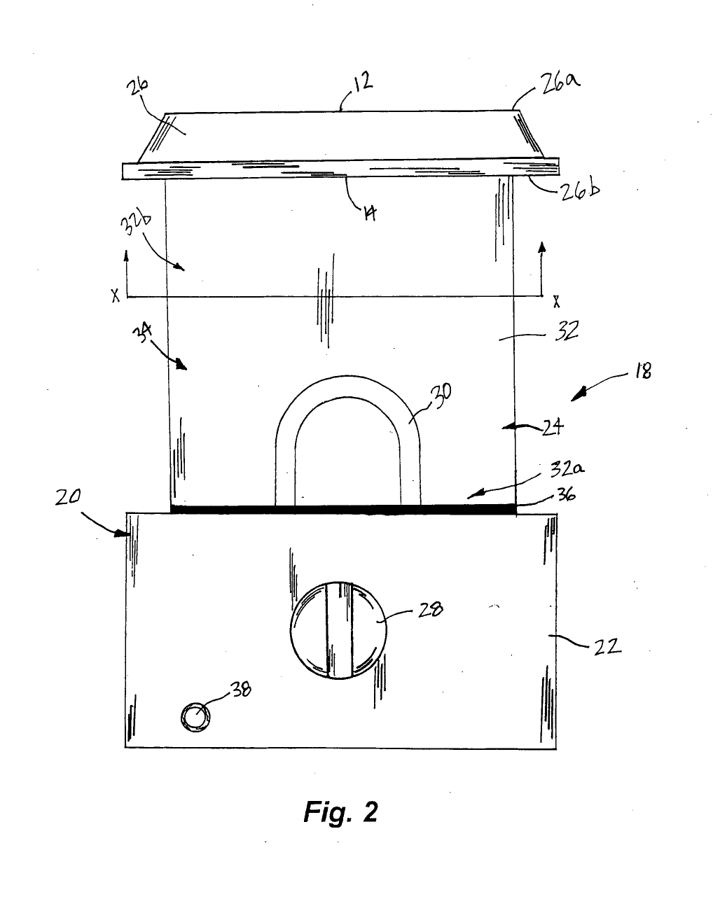

The electronic device 18 may take the form of any device that can receive power from the photovoltaic system 10 of the present invention. In one embodiment, shown in FIGS. 2-3b, the electronic device 18 takes the form of a light, such as the portable lantern 20. With specific reference to FIG. 2, the portable lantern 20 includes a base 22, a light source 24, and a lid 26. The base 22 may comprise a substantially cylindrical structure similar to portable lanterns known in the art. The base 22 retains the electrical storage device 16 and may also include a switch 28 in electrical communication with the electrical storage device 16 for activating the light source 24. The light source 24 may comprise an incandescent or fluorescent bulb 30, one or more light emitting diodes (LEDs), or any other electric light source. When using a fluorescent bulb 30, it attaches to the base 22 via a standard socket (not shown) or otherwise, such that the bulb 30 remains in electrical communication with the electrical storage device 16.

The portable lantern 20 also includes a substantially cylindrical housing 32 positioned around the bulb 30 and attached to the base 22. The housing 32 includes a light transmissive region 34 that enables light to pass and illuminate the area surround the housing 32. The housing 32 may also include light reflective material 36 to assist in directing light energy toward the second photovoltaic cell 14, as discussed below in further detail.

The lid 26 rests on top of the housing 32 and retains the first and second photovoltaic cells 12, 14. With reference to FIGS. 3a and 3b, the first photovoltaic cell 12 resides on an exterior top surface 26a of the lid 26, while the second photovoltaic cell 14 resides on a bottom surface 26b of the lid 26, substantially within the housing 32. In this arrangement, the first and second photovoltaic cells 12, 14, have substantially identical footprints covering substantially the entire surface area of the top and bottom surfaces 26a, 26b. However, the first and second photovoltaic cells 12, 14 may cover any amount of the lid 26 or become positioned on any portion of the lantern to provide the desired amount of electricity. Given the nature of the photovoltaic cells 12, 14 they may reside substantially flush with the top and bottom surfaces 26a, 26b. This provides the portable lantern 20 with an initial overall appearance similar to conventional lanterns. However, the first and second photovoltaic cells 12, 14 provide the lantern 20 with greater electrical power, and therein a longer operating life than conventional lanterns.

Moreover, the photovoltaic system 10 provides the lantern 20 with greater electrical power without using a single, large panel that would make the lantern 20 difficult to transport and use.

As previously mentioned, the first photovoltaic cell 12 on the exterior of the portable lantern 20 captures sunlight, moonlight, or artificial light from sources auxiliary to the portable lantern 20. As the photovoltaic cell 12 receives light, it provides electrical power to the electrical storage device 16 through standard electrical connections known in the art. The amount of electrical power that the first photovoltaic cell 12 may generate will vary with the number and size of the cell used, as well as the amount of light that it receives. On average, during direct sunlight, the first photovoltaic cell 12 may generate 8 volts of electricity to the electrical storage device 16, such as four 1.2 volt “D-size” batteries.

The second photovoltaic cell 14 primarily receives light from the light bulb 30, as well as ambient or natural light, or light sources auxiliary to the lantern 20 that may be reflected to the second photovoltaic cell 14. In one embodiment, when using a 7.0 watt fluorescent bulb, the second photovoltaic cell 14 produces approximately 3.0 volts of electricity. To further increase the amount of light directed to the second photovoltaic cell 14, and therein increase the amount of electricity produced, a portion of the interior of the housing 32 may include reflective material 36. For instance, the reflective material 36 may become positioned around the lower portion 32a of the housing 32 (FIG. 2), around a center portion 32b of the housing 32, or at any other location that enables light transmission from the housing 32 while promoting reflection of light toward the second photovoltaic cell 14. The reflective material 36 may also become positioned on the base 22 or lid 26 to further promote reflection. Similar to the first photovoltaic cell 12, as the second photovoltaic cell 14 receives light, it provides electrical power to the electrical storage device 16 through standard electrical connections. Accordingly, the second photovoltaic cell 14 essentially recaptures some of the electricity used to power the lantern 20 and reuses this electricity in the photovoltaic system 10.

The combination of the first and second photovoltaic cells 12, 14 extends the operating life of the lantern 20 between formal charging of the batteries from a traditional power source, e.g., a power outlet, or replacement of the batteries. For instance, a conventional portable lantern having a 7.0 watt fluorescent bulb and four-1.2 volt “D size” batteries may have an operating life of 6-7 hours of light production before the batteries need to be replaced or formally recharged. Utilizing the photovoltaic system 10 of the present invention dramatically extends this operating life of light production.

In addition to providing the lantern 20 with a greater operating life, the photovoltaic system also enables the lantern to provide power to auxiliary devices. In one embodiment, the lantern 20 may include a power source, such as an outlet 38 (FIGS. 1 and 2) for receiving a power cord and providing electricity to an auxiliary device. The outlet 38 may reside electrically between the electronic device 18 and the electrical storage device 16.

Although shown in FIG. 1 in a parallel connection, the outlet 38 may connect to the photovoltaic system 10 in any manner and reside in any position, such as electrically upstream of the electrical storage device 16. The outlet 38 enables a user to insert a power cable, such as a cellular phone power cable, and use/charge the auxiliary device. Additionally, the power source may include a power cable (not shown), in lieu of or in addition to the outlet 38, for providing electricity to an auxiliary device.

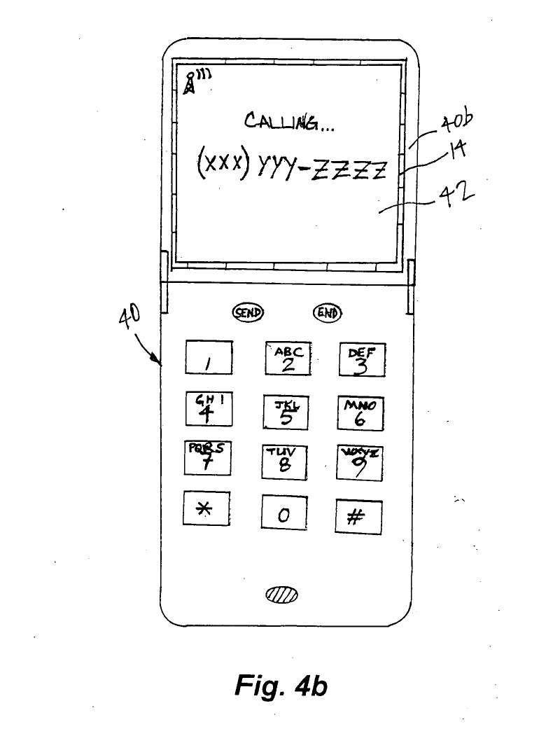

In another embodiment, the electronic device 18 comprises a portable phone utilizing the photovoltaic system 10 of the present invention. As shown in a closed configuration in FIG. 4a and an operational position in FIG. 4b, the cellular phone 40 includes the first photovoltaic cell 12 on the exterior 40a of the phone primarily oriented toward the sun. The second photovoltaic cell 14 resides on the interior 40b of the phone 40 primarily oriented toward the display 42. FIG. 4b shows one embodiment of the phone 40 with the second photovoltaic cell 14 positioned along the periphery of the display 42. Alternatively, the second photovoltaic cell 14 may be positioned behind the display 42 or anywhere else, such that it may receive light from the display. Additionally, the second photovoltaic cell 14 may also reside on an external display 44 of the phone 40. In this configuration, the second photovoltaic cell 14 may receive light from both the external display 44 and other light sources.

The present invention presents a photovoltaic system 10 that may capture and store electrical power from ambient or natural light, as well as capture and store electrical power from the electronic device it powers. This provides the electronic device with a greater operating life. Additionally, this enables the electronic device to provide electricity to auxiliary devices.

The foregoing discussion was chosen to provide the best illustration of the principles of the invention and its practical application to thereby enable one of ordinary skill in the art to utilize the invention in various embodiments and with various modifications suited to the particular use contemplated. For example, although generally referred to as being portable, the electronic device 18 may be fixed and may include such devices as yard and walkway lights. Additionally, the photovoltaic system 10 may include further components, such as amplifiers, transformers, and additional circuits to provide the desired amount of electricity to the electrical storage device 16 and the electronic device 18. Also, the first and second photovoltaic cells 12, 14 may directly power the electronic device, thereby eliminating the need for the electrical storage device 16. All modifications and variations are within the scope of the invention as determined by the claims when interpreted in accordance with the breadth to which they are fairly, legally and equitably entitled.

1. A photovoltaic system, comprising:
a light source;
a first photovoltaic cell primarily oriented toward the sun; and
a second photovoltaic cell primarily oriented toward the light source, wherein the first and second photovoltaic cell provide power to the light source.

2. The photovoltaic system of claim 1, further comprising an electronic device including the light source.

3. The photovoltaic system of claim 2, wherein the electronic device comprises a cell phone.

4. The photovoltaic system of claim 3, wherein the cellular phone includes the first photovoltaic cell on an exterior of the phone and a second photovoltaic cell on an interior of the phone primarily oriented toward a display of the phone.

5. The photovoltaic system of claim 2, wherein the electronic device comprises a portable lantern.

6. The photovoltaic system of claim 5, wherein the first photovoltaic cell is positioned on a lid covering a housing of the portable lantern.

7. The photovoltaic system of claim 5, wherein the first photovoltaic cell is positioned on a top surface of a lid covering a housing of the portable lantern and the second photovoltaic cell is positioned on a bottom surface of the lid.

8. The photovoltaic system of claim 1, wherein the first and second photovoltaic cells are in electrical communication with an electrical storage device.

9. The photovoltaic system of claim 2, wherein the electronic device includes a power source for providing electricity to an auxiliary device.

10. The photovoltaic system of claim 9, wherein the power source is an outlet for receiving a power cord and providing electricity to an auxiliary device.

11. The electronic device of claim 1, further comprising reflective material for promoting reflection of light toward the second photovoltaic cell.

12. An electronic device, comprising:
a housing containing a light source;
a first photovoltaic cell on the housing and oriented primarily toward the sun; and
a second photovoltaic cell on the housing and oriented primarily toward the light source.

13. The light of claim 12, wherein the first and second photovoltaic cells reside in electrical communication with an electrical storage device.

14. The light of claim 13, wherein the electrical storage device includes at least one rechargeable battery.

15. The light of claim 12, wherein the first photovoltaic cell resides on an exterior top surface of the housing.

16. The light of claim 12, wherein the first and second photovoltaic cells have substantially identical footprints.

17. An electronic device at least partially powered by a photovoltaic system, comprising:
a housing including a light transmissive region that enables light to pass and illuminate an area surround the housing;
a light source positioned within the housing;
a first photovoltaic cell positioned on a top surface of the housing primarily oriented toward the sun and a second photovoltaic cell primarily oriented toward the light source.

18. The electronic device of claim 17, wherein the electronic device comprises a portable lantern having a lid positioned on top of the housing, the lid retaining the first and second photovoltaic cell.

19. The electronic device of claim 18, wherein the first photovoltaic cell resides substantially outside the housing and the second photovoltaic cell resides substantially within the housing.

20. The electronic device of claim 18, wherein the first and second photovoltaic cells have substantially identical footprints.

21. The electronic device of claim 20, wherein the first and second photovoltaic cells are in electrical communication with an electrical storage device.

22. The electronic device of claim 17, wherein the housing also includes reflective material to assist in directing light energy toward the second photovoltaic cell.

23. The electronic device of claim 17, further including a power source for providing electricity to an auxiliary device.

24. The electronic device of claim 23, wherein the power source is an outlet for receiving a power cord and providing electricity to an auxiliary device.

25. The electronic device of claim 17, wherein the first and second photovoltaic cell each include a positive and negative terminal, the negative terminal of the first photovoltaic cell and a positive terminal of the second photovoltaic cell are electrically connected, and the positive terminal of the first photovoltaic cell and the negative terminal of the second photovoltaic cell are electrically connected to an electrical storage device for providing electricity to the electrical storage device.

26. The electronic device of claim 17, further comprising an electrical storage device positioned electrically between the first and second photovoltaic cell and the light source.

27. The electronic device of claim 17, further comprising an electrical storage device residing electrically upstream of the light source and a power source for providing electricity to an auxiliary device.
